(19) United States
(12) Patent Application Publication
(10) Pub. No.: US 2008/0168713 A1
(43) Pub. Date: Jul. 17, 2008

(54) Remote controlled overhead garage door locking mechanism

(76) Inventor: Grigoriy Mogilevskiy, Columbus, OH (US)

Correspondence Address: Grigoriy Mogilevskiy, 128 South Ogden Ave., Columbus, OH, 43204, US

(21) Appl. No.: 11/594,262

(22) Filed: Nov. 8, 2006

(51) Int. Cl. E05F 15/16

(52) U.S. Cl. 49/199; 49/506

(57) ABSTRACT

A remote controlled overhead garage door locking mechanism including a power supply, a control box containing a radio-receiver and a reversing polarity module, an actuator, a housing with a sliding bar, a limit switch, a power relay, and the remote radio-transmitter with two (LOCK and UNLOCK) buttons. The mention locking mechanism could be used with any garage door opener and provide comfort of operation by remote control from a distance. When the garage door is locked, the circuitry comprising a limit switch and power relay turns OFF power from the garage door opener to prevent possible damage to the door itself or to the garage door opener mechanism.

### BACKGROUND OF THE INVENTION

1. Field of the Invention This invention related to a remote controlled lock for overhead garage door with remote controlled opener, and offers the independently working remote-controlled lock, compatible with any opener.

2. Description of the Related Art

The remote-controlled garage door opener is a well-known device providing a valuable convenience for users. However, the security of the garage door with a remote-controlled opener is insufficient, and intruder doesn't need any sophisticated action or equipment to break in. The invention lets achieve an appropriate security to the dwelling with any installed opener.

### SUMMARY OF THE INVENTION

The objective of this invention is to offer a remote-controlled overhead garage door locking mechanism compatible with any garage door opener to provide security to the dwelling.

### BRIEF DESCRIPTION OF THE DRAWINGS

FIG. 1 is a block diagram of the remote-controlled overhead garage door locking mechanism.

### DETAILED DESCRIPTION OF THE PREFERRED EMBODIMENT

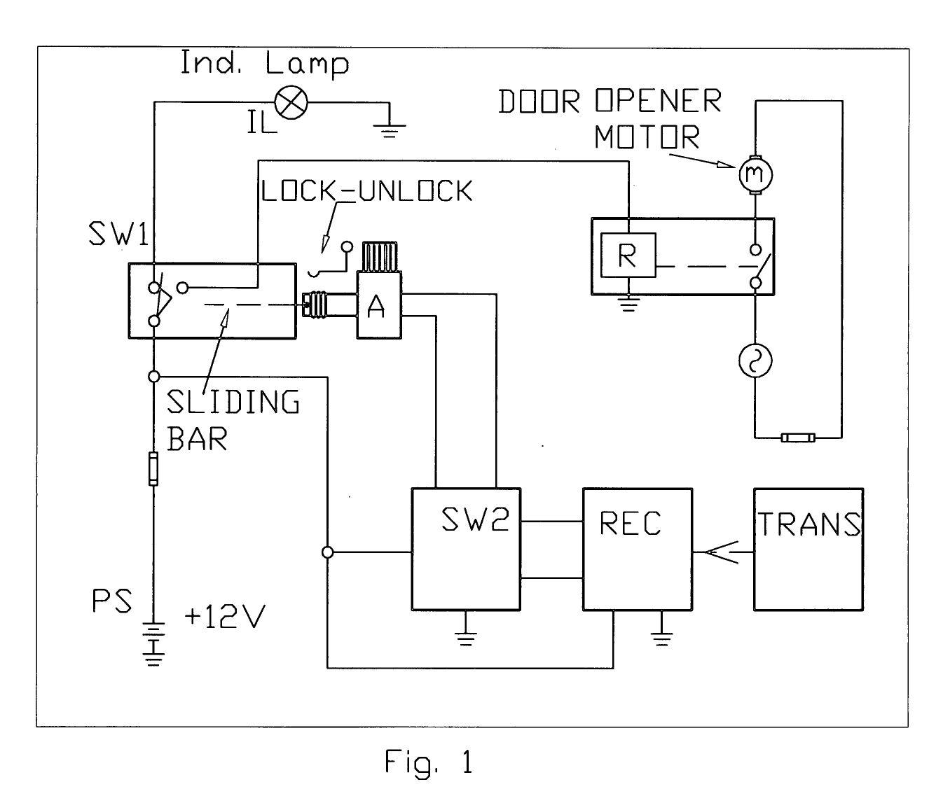

A preferred embodiment of a remote-controlled overhead garage door locking mechanism in the present invention, as shown in FIG. 1 includes a power supply PS1, a remote control radio transmitter TRANS, a radio receiver REC, a reverse polarity switch SW2, an actuator A, a limit switch SW1, a power relay R and an indicator lamp IL.

When a receiver REC detects the LOCK radio-signal sent from remote control TRANS it makes the reverse polarity module SW2 apply the power to the actuator A moving the sliding bar into the LOCK position.

Once the sliding bar comes in the LOCK position it, pushes the limit switch SW1 in LOCK position, locks the overhead garage door and remain in that position.

Said limit switch SW1 activates the power relay R removing the power from overhead garage door opener and turns ON the indicator lamp IL.

When the receiver REC detects the UNLOCK radio-signal from the remote control TRANS, it makes the reverse polarity module SW2 apply the power to the actuator A moving the sliding bar into the UNLOCK position.

Once the sliding bar comes in the UNLOCK position it unlocks the overhead garage door, releases the limit switch SW1, and remains in that position.

Said limit switch SW1 activates the power relay R return power to the overhead garage door opener and turns OFF the indicator lamp IL.

All changes, modification, variation and other uses related with the independent overhead door locking mechanism, possessing of any switching device, deactivating the overhead garage door opener in LOCK, and activating in UNLOCK position must fall within the spirit and score of the invention.

What is claimed is:

1. A remote controlled door locking mechanism for an overhead garage door comprising a housing with a sliding bar installed inside on a garage wall said sliding bar moved by actuator, controlled through a reverse polarity module by a radio receiver circuitry powered by 12V DC power supply, and electrical circuitry, comprising a limit switch and power relay, that control the power to the overhead garage door opener.

2. A method for controlling the power to the motor driven overhead garage door opener including the steps of removing power (through a limit switch and power relay) from the garage door opener when the door locking bar is moved into LOCK position disabling the garage door opener, and turning the power back ON when the door locking bar is moved into UNLOCK position.
